(19) United States
(12) Patent Application Publication
(10) Pub. No.: US 2026/0126409 A1
(43) Pub. Date: May 7, 2026

(54) OPTOELECTRODE ARRAYS BY HIERARCHIAL MODULAR DESIGN

(71) Applicant: VIRGINIA TECH INTELLECTUAL PROPERTIES, INC., Blacksburg, VA (US)

(72) Inventors: Elieser Mejia, Hanover, MD (US); Wei Zhou, Blacksburg, VA (US)

(21) Appl. No.: 19/118,256

(22) PCT Filed: Oct. 6, 2023
(86) PCT No.: PCT/US23/76254

§ 371 Date: Apr. 3, 2025

Related U.S. Application Data
(60) Provisional application No. 63/378,745, filed on Oct. 7, 2022.

(51) Int. Cl. G01N 27/327

(52) U.S. Cl. CPC G01N 27/3278

(57) ABSTRACT

Concepts directed to multi-modal bio-interfacing devices and methods for fabricating and implementing the same are described. In one example, a device for bio-interfacing applications includes a multi-modal bio-interfacing structure formed on a substrate. The multi-modal bio-interfacing structure includes a microelectrode pad formed on the substrate and a micropillar electrode extending from the microelectrode pad. The multi-modal bio-interfacing structure further includes a plurality of nanoantennas formed on the micropillar electrode.

### CROSS REFERENCE TO RELATED APPLICATIONS

This application claims the benefit of and priority to U.S. Provisional Application Ser. No. 63/378,745, filed Oct. 7, 2022, titled “OPTOELECTRODE ARRAYS BY HIERARCHICAL MODULAR DESIGN,” the entire contents of which are hereby incorporated herein by reference.

### STATEMENT REGARDING FEDERALLY SPONSORED RESEARCH OR DEVELOPMENT

This invention was made with government support under Grant No. FA9550-18-1-0328 awarded by the Air Force Office of Scientific Research. This invention was also made with government support under Grant No. 70NANB19H163 awarded by the National Institute of Standards and Technology. The government has certain rights in the invention.

### BACKGROUND

Living multicellular systems feature complex adaptive biological activities coordinated by coupled bioelectrical and biochemical signaling pathways across various spatial and temporal scales. Accessing and resolving such spatiotemporal correlations between bioelectrical and biochemical processes in living systems remains a formidable challenge impeding the understanding of complex biological activities. With the increasing availability of micro-/nano-fabrication tools, the past two decades have seen advances in micro-/nano-scale bioelectronic, biophotonic, biochemical, and biomimetic devices for biosensing and bioanalysis of living systems.

### SUMMARY

The present disclosure is directed to a multi-modal bio-interfacing device and methods for fabricating and implementing the same. In particular, described herein is a modular design approach and an integrated top-down fabrication process for fabricating multi-modal two-tier micro-/nano-optoelectrodes on a substrate. The multi-modal two-tier micro-/nano-optoelectrodes may be embodied as micropillar electrodes having plasmonic nanoantennas formed thereon. The multi-modal bio-interfacing device of the present disclosure may be implemented to perform one or more bio-interfacing operations in various living multicellular systems. For instance, the multi-modal bio-interfacing device may be implemented to perform bioelectrical, biochemical, biophotonic, and biomimetic operations or other bio-interfacing operations in neuronal network cultures, stem-cell scaffolds, cancerous organoids, and microbial films, among other living systems.

Aspects and advantages of embodiments of the present disclosure will be set forth in part in the following description or can be learned from the description or through practice of the embodiments. Other aspects and advantages of embodiments of the present disclosure will become better understood with reference to the appended claims and the accompanying drawings, all of which are incorporated in and constitute a part of this specification. The drawings illustrate example embodiments of the present disclosure and, together with the description, serve to explain the related concepts of the present disclosure.

According to one example embodiment, a device for bio-interfacing applications includes a multi-modal bio-interfacing structure formed on a substrate. The multi-modal bio-interfacing structure includes a microelectrode pad formed on the substrate and a micropillar electrode extending from the microelectrode pad. The multi-modal bio-interfacing structure further includes a plurality of nanoantennas formed on the micropillar electrode.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the concepts of the disclosure. Moreover, repeated use of reference characters or numerals in the figures is intended to represent the same or analogous features, elements, or operations across different figures. Repeated description of such repeated reference characters or numerals is omitted for brevity.

FIG. 1A illustrates a cross-sectional side-view of an example bio-interfacing device including an example multi-modal bio-interfacing structure according to at least one embodiment of the present disclosure.

FIG. 1B illustrates a perspective view of the example multi-modal bio-interfacing structure of FIG. 1A according to at least one embodiment of the present disclosure.

FIG. 1C illustrates another perspective view of the multi-modal bio-interfacing structure of FIG. 1A according to at least one embodiment of the present disclosure.

FIG. 1D illustrates a cross-sectional side-view of an example nanoantenna formed on an example micropillar electrode of the multi-modal bio-interfacing structure of FIG. 1A according to at least one embodiment of the present disclosure.

FIG. 2A illustrates a perspective view of an example bio-interfacing device according to at least one embodiment of the present disclosure.

FIG. 2B illustrates a top-down view of example multi-modal bio-interfacing structure arrays and example contact lines of the bio-interfacing device of FIG. 2A according to at least one embodiment of the present disclosure.

FIG. 2C illustrates a top-down view of an example subset of the multi-modal bio-interfacing structure arrays and an example subset of the contact lines of the bio-interfacing device of FIG. 2A according to at least one embodiment of the present disclosure.

FIG. 2D illustrates a perspective view of example micropillar electrodes extending from an example microelectrode pad of the bio-interfacing device of FIG. 2A according to at least one embodiment of the present disclosure.

FIG. 2E illustrates a perspective view of example nanoantennas formed on an example micropillar electrode of the bio-interfacing device of FIG. 2A according to at least one embodiment of the present disclosure.

FIG. 2F illustrates a cross-sectional side-view of an example nanoantenna formed on an example micropillar electrode of the bio-interfacing device of FIG. 2A according to at least one embodiment of the present disclosure.

FIG. 3 illustrates a flow diagram of an example fabrication method 300 according to at least one embodiment of the present disclosure.

### DETAILED DESCRIPTION

Living multicellular systems, ranging from neuronal networks to cancerous tumors and microbial biofilms, feature dynamic, heterogeneous, and adaptive biological activities coordinated by cellular interactions through various bioelectrical and biochemical signaling pathways. Unfortunately, conventional bioanalysis methods based on single-modal end-point measurements have difficulty resolving spatiotemporal correlations between bioelectrical and biochemical processes in living systems, impeding the understanding of complex biological activities from a holistic systems-biology approach. Therefore, it is desirable to establish new methods for multimodal spatiotemporal measurements of multiple correlated bioelectrical and biochemical processes across multicellular systems. One current approach involves using bio-interfaced multifunctional micro-/nano-sensor arrays with complementary bioelectronic-biophotonic detection modalities to allow multimodal spatiotemporal measurements of living multicellular systems.

With the increasing availability of micro-/nano-fabrication tools, the past two decades have seen significant advances in micro-/nano-scale bioelectronic and biophotonic devices for biosensing and bioanalysis of living systems. For example, micro-/nano-electrode arrays have demonstrated great utility for spatiotemporal measurements of bioelectrical activities in networks of electrogenic cells, including neurons and cardiac myocytes. Notably, micro-/nano-electrodes with protruding biomimetic topologies, such as micro-/nanopillar structures, can elicit spontaneous cell engulfment behaviors for a tight device-cell coupling to achieve intracellular-like electrical recording of membrane potentials in electrogenic cells. Additionally, plasmonic nanoantennas made of noble metal nanostructures can concentrate light at the nanoscale to enable surface-enhanced Raman spectroscopy (SERS) biochemical analyses of living cells with molecular vibrational fingerprint information. However, despite the apparent benefits, there is little research and development of micro-/nano-optoelectrodes (i.e., combined micro-/nano-electrode and nanoantenna devices) in large arrays for multimodal spatiotemporal measurements of bioelectrical and biochemical information in living systems. In particular, there is a lack of a system-level modular design approach to create bio-interfaced micro-/nano-optoelectrode arrays with optimized hybrid device properties for achieving multimodal bioelectrical recording, SERS biochemical analyses, and tight nanodevice-cell coupling by biomimetic design.

A significant challenge limiting the modular design space resides in the difficulty of patterning nanoscale features on non-planar large-scale—(e.g., centimeter (cm) scale) areas using conventional nanofabrication techniques such as electron-beam lithography or ion-beam milling. Alternatively, light can be used to pattern both micro- and nanoscale features, opening opportunities for a modular design approach. For example, modern additive fabrication techniques based on stereolithography and 2-photon polymerization have enabled rapid prototyping of complex three-dimensional (3D) micro-/nano-scale features, which potentially can be used to create next-generation micro-/nanostructured optical, electrical, and mechanical systems. Standard mask/maskless photolithography-based fabrication techniques have also been employed to create 3D micro-scale features with sizes constrained by the diffraction limit and penetration depth of ultraviolet (UV) light in photoresists. Advanced photolithography techniques using phase-shifting interference effects can directly generate nano-patterns. Despite significant efforts, it remains challenging for existing light-based fabrication techniques to achieve modularized integration of micro-/nano-scale building blocks with different constituent materials.

Embodiments of the present disclosure provide solutions to at least the aforementioned challenges associated with fabricating multi-modal micro-/nano-scale bio-interfacing devices using a system-level modular design approach to fabricate micro-and nanoscale components of such devices. Various examples herein describe a hierarchical modular design and fabrication methodology to integrate multi-resonant plasmonic nanoantenna arrays on top of micropillar electrode arrays, to produce a general class of two-tier protruding micro-/nano-optoelectrode arrays. The micro-/nano-optoelectrode arrays feature biomimetic topology and complementary biophotonic-bioelectronic modalities for bioelectrical recording and SERS biochemical detection. In one example, the hierarchical modular fabrication method involves a multilayer lift-off process to create 3D protruding structures with electrical interconnects. The fabrication method in this example further involves soft interference lithography to create nanohole array deposition masks for patterning metallic-dielectric nanoscale features on hierarchical surfaces.

The multi-modal bio-interfacing device, as well as the hierarchical modular design and fabrication methodology described herein provide numerous technical advantages and benefits. For example, the combination of nanolaminate nanoantennas and conductive micropillars as described in embodiments herein elicits unique optical and electrical characteristics that can be exploited with further optimization and experimentation. For optical characteristics, the micro-reflectance of a single micro-/nano-optoelectrode described herein showed a double-resonant optical response in the visible/near-infrared window in many examples because of the excitation of multiple hybridized plasmonic modes. Stokes inelastic scattering signals from a bound thiol molecule enjoyed a six-order of magnitude enhancement in many examples due to the nanoantenna's intense near-field enhancement and spectral mode overlap at the laser excitation wavelength. The calculated far-field and near-field optical properties observed from one example multi-modal bio-interfacing device described herein using the finite-difference time-domain (FDTD) method revealed that measured high SERS enhancement factors (e.g., ≈10⁶) resulted from intense localized optical fields due to constructive near-field interference of multipolar plasmonic modes in nanolaminate nanoantennas with their induced image in the metallic mirror ground plane. For electrical characteristics in 1× phosphate-buffered saline, electrochemical impedance measurements obtained for one example multi-modal bio-interfacing device described herein showed one order of magnitude reduction in the electrochemical impedance due to an increase in electrochemically active surface area compared to a planar electrode. Furthermore, cyclic voltammograms obtained for one example multi-modal bio-interfacing device described herein revealed large charging currents for the device's micro-/nano-optoelectrodes compared to planar electrodes due to the more extensive electric double layer (EDL) at the interface between the conductive 3D electrode and aqueous electrolyte. Such relatively larger charging currents may also benefit other applications such as, for instance, supercapacitors, fuel cells, electroporation devices, and dielectrophoretic devices, among possibly others.

Additionally, the integration of plasmonic nanoantennas with protruding micropillar electrodes on multi-electrode arrays by a novel CMOS-compatible fabrication processes enables the potential scalable dissemination of multi-functional sensors for in-situ correlated spatiotemporal bioelectrical-biochemical measurements of living multicellular systems such as neuronal network cultures, stem-cell scaffolds, cancerous organoids, and microbial films. Further, the hierarchical modular design and fabrication approach described herein may be implemented to create scalable two-tier protruding micro-/nano-optoelectrode arrays. In addition, the modularized approach of the present disclosure also allows for an extended design space of biomimetic micro-/nano-pillar topology, plasmonic nanoantenna-based biophotonic function in surface-enhanced Raman spectroscopy (SERS), and micro-/nano-electrode-based photoelectronic function in electrochemical impedance spectroscopy.

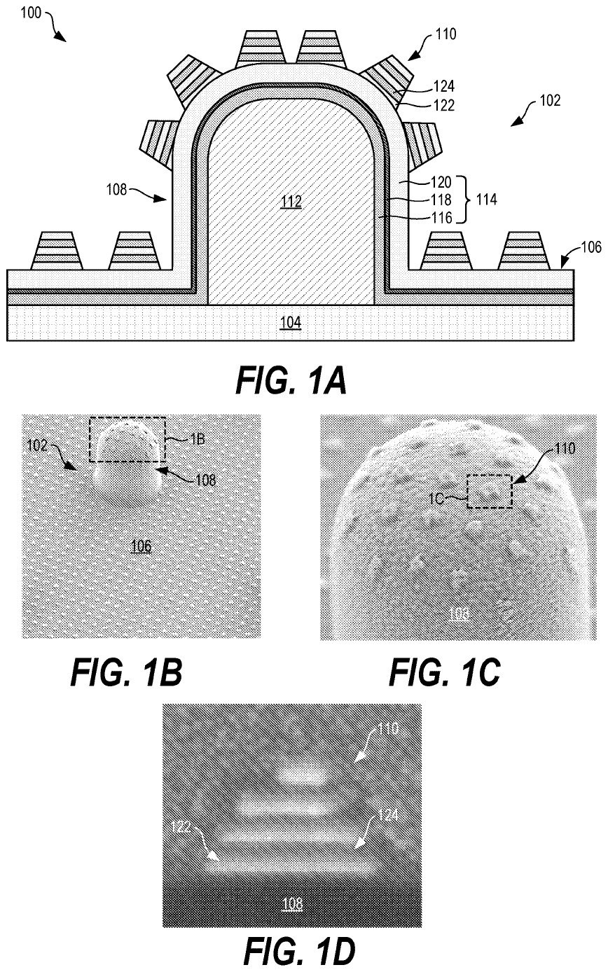

Turning now to the figures, FIGS. 1A to 1D collectively illustrate various views of an example bio-interfacing device 100 and example components thereof according to at least one embodiment of the present disclosure. FIG. 1A illustrates a cross-sectional side-view of the example bio-interfacing device 100 including an example multi-modal bio-interfacing structure 102 formed on a substrate 104 according to at least one embodiment of the present disclosure. FIG. 1B illustrates a perspective view of the multi-modal bio-interfacing structure 102 according to at least one embodiment of the present disclosure. In this example, FIG. 1B illustrates a perspective view of a microelectrode pad 106 of the multi-modal bio-interfacing structure 102, a micropillar electrode 108 extending from the microelectrode pad 106, and a plurality of nanoantennas 110 formed on the microelectrode pad 106 and the micropillar electrode 108. In this example, a bounding box 1B depicted in FIG. 1B includes the nanoantennas 110 formed on the micropillar electrode 108. FIG. 1C illustrates another perspective view of the multi-modal bio-interfacing structure 102 according to at least one embodiment of the present disclosure. In this example, FIG. 1C illustrates a perspective view of the nanoantennas 110 included in the bounding box 1B of FIG. 1B. In this example, a bounding box 1C depicted in FIG. 1C includes a single nanoantenna 110 formed on the micropillar electrode 108. FIG. 1D illustrates a cross-sectional side-view of a nanoantenna 110 formed on a micropillar electrode 108 of the multi-modal bio-interfacing structure 102 according to at least one embodiment of the present disclosure. In this example, FIG. 1D illustrates a cross-sectional side-view of the nanoantenna 110 included in the bounding box 1C of FIG. 1C. In this example, FIG. 1D illustrates the nanoantenna 110 embodied as a multi-layer nanostructure formed on the micropillar electrode 108 of the multi-modal bio-interfacing structure 102.

With reference to FIGS. 1A to 1D, collectively, the bio-interfacing device 100 includes a multi-modal bio-interfacing structure 102 formed on a substrate 104. The multi-modal bio-interfacing structure 102 includes a microelectrode pad 106 formed on the substrate 104, a micropillar electrode 108 extending from the substrate 104 and the microelectrode pad 106, and a plurality of nanoantennas 110 formed on the micropillar electrode 108. Only a single nanoantenna 110 is denoted in the FIGS. 1A to 1D for clarity. The multi-modal bio-interfacing structure 102 in this example is embodied as a micro-nano pillar-shaped optoelectrode structure that extends from the substrate 104 and the microelectrode pad 106. For instance, such a micro-nano optoelectrode structure in this example includes the micropillar electrode 108 with the nanoantennas 110 formed thereon. The multi-modal bio-interfacing structure 102 may be embodied and/or implemented as at least one of a bioelectrical microelectrode, a biochemical microelectrode, a bioelectrical-biochemical microelectrode, a biophotonic microelectrode, or a biomimetic microelectrode according to various examples described herein.

The substrate 104 in this example can be embodied as any structure on which integrated circuits, such as one or more multi-modal bio-interfacing structures 102 described herein, can be formed and that is capable of supporting such structures. In the example shown, the substrate 104 can be embodied as and/or include at least one of a polymer material or composite, a metal material or alloy, a glass material or composite, a fiberglass material, a rigid or flexible circuit board (e.g., a rigid or flexible printed circuit board), a silicon (Si) material or wafer, or another type of material or substrate.

The micropillar electrode 108 in this example includes a polymeric micropillar 112 extending from the substrate 104 and a conductive layer 114 formed on the polymeric micropillar 112. The polymeric micropillar 112 may be formed using, and thus may include, for instance, at least one of a polymer material (e.g., any polymer that cross-links and/or polymerizes when exposed to light (e.g., ultra violet (UV) light)), a perfluoropolyether material, a photoinitiator material, a polyurethane material, an epoxy-based negative photoresist material, or another material. In one example, the polymeric micropillar 112 may be formed using, and thus may include, a perfluoropolyether material with at least one of a photoinitiator or a polyurethane material. In another example, the polymeric micropillar 112 may be formed using, and thus may include an epoxy-based negative photoresist material. As described in further detail herein, the microelectrode pad 106 is formed from a first section of the conductive layer 114 and an outer portion of the micropillar electrode 108 is formed from a second section of the conductive layer 114. The conductive layer 114 is embodied as multiple layers in this example, including at least one of a dielectric layer 116, an adhesive layer 118, or a noble metal layer 120. In some cases, other layer types may be relied upon to form the conductive layer 114. In the example shown, the dielectric layer 116 is formed on the polymeric micropillar 112, the adhesive layer 118 is formed on the dielectric layer 116, and the noble metal layer 120 is formed on the adhesive layer 118, although other arrangements may be relied upon in some cases. For instance, an additional adhesive layer 118 may be formed between the polymeric micropillar 112 and the dielectric layer 116 in some cases.

In one example, the conductive layer 114 includes a silicon dioxide (SiO₂) layer as the dielectric layer 116, a chromium (Cr) layer as the adhesive layer 118, and a gold (Au) layer as the noble metal layer 120, although another material may be relied upon for any layer in some cases. The thickness of each of such layers may be the same in some cases or different in others. In some examples, the thickness of the dielectric layer 116 (e.g., SiO₂ layer) may range from approximately 10 to 50 nanometers (nm) thick, the thickness of the adhesive layer 118 (e.g., Cr layer) may range from approximately 5 to 50 nm thick, and the thickness of the noble metal layer 120 (e.g., Au layer) may range from approximately 50 to 150 nm thick, although another material and/or thickness may be relied upon for any or all of such layers in some cases. In one particular example, the dielectric layer 116 may be formed as an SiO₂ layer that is approximately 30 nm thick, the adhesive layer 118 may be formed as a Cr layer that is approximately 10 nm thick, and the noble metal layer 120 may be formed as an Au layer that is approximately 100 nm thick, although another material and/or thickness may be relied upon for any or all of such layers in some cases.

The nanoantennas 110 in this example may be embodied as an array of optical nanoantennas. For instance, the nanoantennas 110 may be formed as an array of plasmonic nanoantennas. In one particular example, the nanoantennas 110 may be formed as an array of multi-resonant plasmonic nanoantennas. In the example shown, each of the nanoantennas 110 is embodied as a multi-layer nanostructure including at least one of an adhesive layer (not illustrated in FIG. 1A for clarity), a noble metal layer 122, an interfacial adhesive layer (not illustrated in FIG. 1A for clarity), or a dielectric layer 124. In some cases, other layer types and/or various arrangements of such layers may be relied upon to form any or all of the nanoantennas 110. Only a single noble metal layer 122 and a single dielectric layer 124 are denoted in FIG. 1A for clarity.

In the example shown, alternating deposits of an adhesive layer, the noble metal layer 122, an interfacial adhesive layer, and the dielectric layer 124 are formed on curved surfaces of the micropillar electrode 108 to construct the nanoantennas 110 on such curved surfaces. An adhesive layer (not illustrated) is formed on the noble metal layer 120 of the conductive layer 114 and a first multiple noble metal layer 122 of each of the nanoantennas 110 is formed on the adhesive layer. An interfacial adhesive layer (not illustrated) is formed on such a first noble metal layer 122 and the dielectric layer 124 is formed on the interfacial adhesive layer. Additional deposits of the interfacial adhesive layer are also formed between each pair of the noble metal layer 122 and the dielectric layer 124 of each of the nanoantennas 110. However, other arrangements of the layers of any or all of the nanoantennas 110 may be relied upon in some cases. In the example shown, any or all of the nanoantennas 110 may be formed as described herein and illustrated in FIG. 1D.

In one example, each of the nanoantennas 110 includes a chromium (Cr) layer as an adhesive later, a gold (Au) layer as the noble metal layer 122, a titanium (Ti) layer as an interfacial adhesive layer, and a silicon dioxide (SiO₂) layer as the dielectric layer 124, although another material may be relied upon for any layer in some cases. The thickness of each of such layers may be the same in some cases or different in others. In some examples, the thickness of the adhesive layer (e.g., Cr layer) may range from approximately 0.1 to 5 nm thick, the thickness of the noble metal layer 122 (e.g., Au layer) may range from approximately 5 to 20 nm thick, the thickness of the interfacial adhesive layer (e.g., Ti layer) may range from approximately 0.1 to 5 nm thick, and the thickness of the dielectric layer 124 (e.g., SiO₂ layer) may range from approximately 5 to 20 nm thick, although another material and/or thickness may be relied upon for any or all of such layers in some cases. In one particular example, the adhesive layer may be formed as a Cr layer that is approximately 1 nm thick, the noble metal layer 120 may be formed as an Au layer that is approximately 12 nm thick, the interfacial adhesive layer may be formed as a Ti layer that is approximately 0.7 nm thick, and the dielectric layer 124 may be formed as an SiO₂ layer that is approximately 9 nm thick, although another material and/or thickness may be relied upon for any or all of such layers in some cases.

As illustrated in FIGS. 1A, 1B, and 1C, the nanoantennas 110 may be formed on at least one of the microelectrode pad 106 or the micropillar electrode 108 according to at least one defined pattern. In the example shown, all of the nanoantennas 110 are formed on the microelectrode pad 106 and the micropillar electrode 108 according to the same defined pattern. However, in some cases, a first subset of the nanoantennas 110 may be formed on the microelectrode pad 106 in a first defined pattern and a second subset of the nanoantennas 110 may be formed on the micropillar electrode 108 in a second defined pattern. In other examples, a first subset of the nanoantennas 110 may be formed on the microelectrode pad 106 and/or the micropillar electrode 108 in a first defined pattern and a second subset of the nanoantennas 110 may be formed on the microelectrode pad 106 and/or the micropillar electrode 108 in a second defined pattern. The nanoantennas 110 may be formed on various surface geometries. In the example shown, a first subset of the nanoantennas 110 is formed on a planar, flat surface of the microelectrode pad 106 and a second subset of the nanoantennas 110 is formed on a non-planar, curved surface of a distal end of the micropillar electrode 108.

Although not illustrated in FIGS. 1A to 1D, in some cases, the bio-interfacing device 100 may further include at least one contact line that is formed on the substrate 104 and coupled to at least one of the microelectrode pad 106, the micropillar electrode 108, or the nanoantennas 110. Additionally, although not illustrated in the example shown, in some cases, the bio-interfacing device 100 may further include a contact pad that is formed on the substrate 104 and coupled to such a contact line. As described in further detail herein, in some examples, the contact line and contact pad may be respectively formed from different sections of the conductive layer 114. For instance, the contact line and contact pad may be respectively formed from a third and a fourth section of the conductive layer 114 that are different from the above-described first and second sections of the conductive layer 114 used to respectively form the microelectrode pad 106 and an outer portion of the micropillar electrode 108.

Although not illustrated, in some cases, the bio-interfacing device 100 may further include a passivation layer formed on at least a portion of the aforementioned contact line. The passivation layer may be formed on the contact line so as to encapsulate, protect, and/or insulate at least a portion of the contact line upon which the passivation layer is formed. For instance, the passivation layer may be formed on the contact line so as to encapsulate, protect, and/or insulate at least a portion of the conductive layer 114 used to form the contact line upon which the passivation layer is formed.

The passivation layer may be formed to a thickness ranging from approximately 500 nm to 2 micrometers (μm), although other thicknesses may be relied upon in some cases. The passivation layer may be formed using, and thus may include, for instance, at least one of a dielectric polymer (e.g., an epoxy-based negative photoresist material), a polyimide material, or a deposited dielectric material (e.g., silicon dioxide (SiO₂), titanium dioxide (TiO₂), or silicon nitride (Si₃N₄)), although other materials may be relied upon in some cases. In one example, the passivation layer may be formed on the contact line using a top-passivation process. The top-passivation process may include, for instance, at least one of a photolithography process, a physical vapor deposition (e.g., e-beam or sputtering) process, a chemical vapor deposition (e.g., atomic layer deposition) process, or dry and/or wet chemical etching process, or another top-passivation process.

The bio-interfacing device 100 may be used to perform various bio-interfacing operations in different living systems. In one example, the bio-interfacing device 100 may be implemented to perform one or more sensing or interactive bio-interfacing operations in various living multicellular systems. For instance, the bio-interfacing device 100 may be implemented to perform at least one of bioelectrical, biochemical, biophotonic, or biomimetic operations in neuronal network cultures, stem-cell scaffolds, cancerous organoids, and microbial films, among other living systems. The bio-interfacing device 100 may be implemented to perform several of such bio-interfacing operations sequentially in some examples, or concurrently (e.g., simultaneously) in other examples.

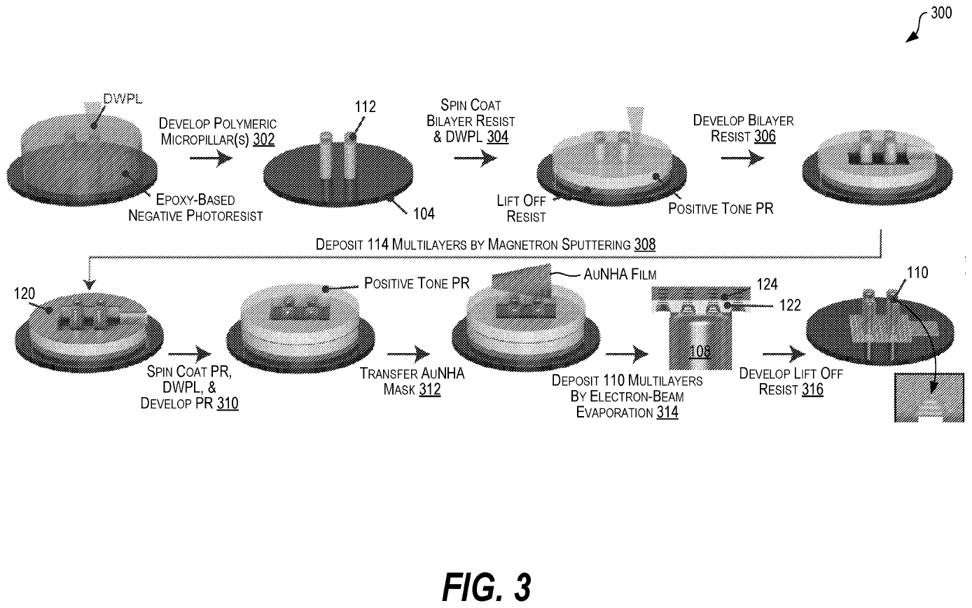

The design of the micropillar electrode 108 and/or the nanoantennas 110 such as the shape, materials used, and material arrangement, among other aspects, may vary depending on a particular bio-interfacing application or to achieve a desired result from a particular bio-interfacing operation. The bio-interfacing device 100 and/or any of the components thereof, such as the multi-modal bio-interfacing structure 102, can be fabricated according to method 300 described herein with reference to FIG. 3. The method 300 provides a modular design approach and an integrated top-down fabrication process for fabricating multi-modal two-tier micro-/nano-optoelectrodes on a substrate to form one or more of the bio-interfacing devices described in examples herein.

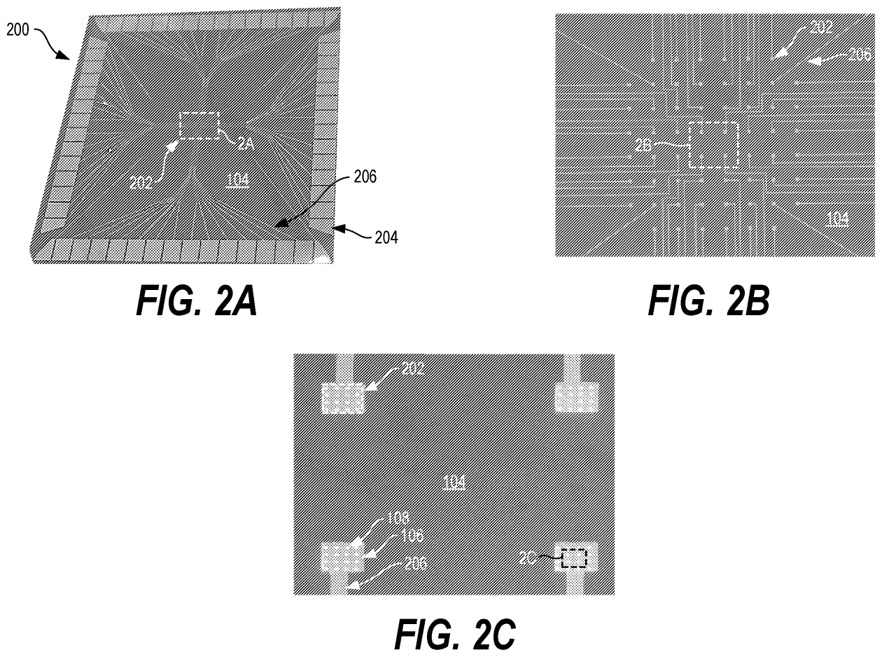

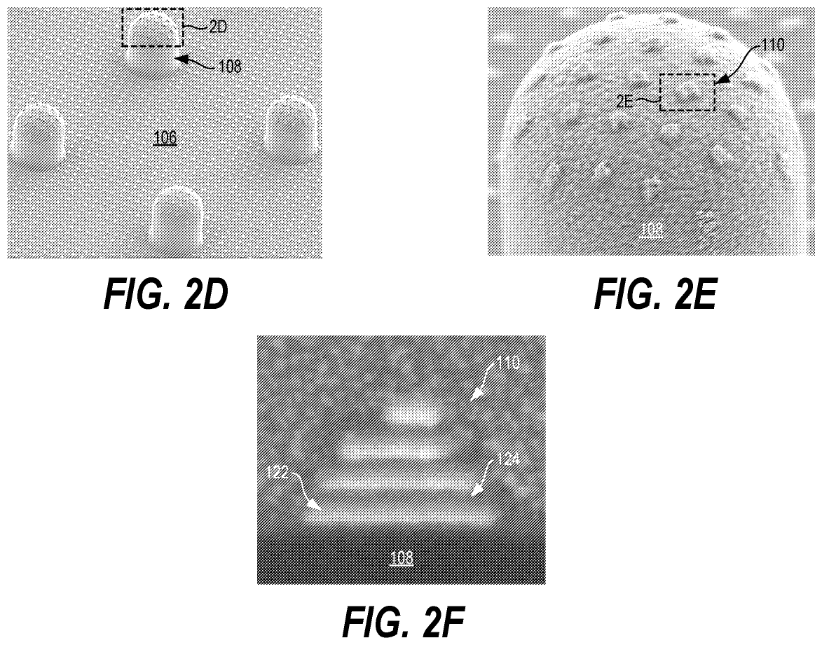

FIGS. 2A to 2F collectively illustrate various views of another example bio-interfacing device 200 and example components thereof according to at least one embodiment of the present disclosure. FIG. 2A illustrates a perspective view of the bio-interfacing device 200 including a plurality of multi-modal bio-interfacing structure arrays 202 (FIGS. 2B and 2C) formed on the substrate 104 according to at least one embodiment of the present disclosure. In this example, the bio-interfacing device 200 further includes a plurality of contact pads 204 and a plurality of contact lines 206 formed on the substrate 104. The contact pads 204 are respectively coupled to the contact lines 206, and the contact lines 206 are respectively coupled to the multi-modal bio-interfacing structure arrays 202 in the example shown. In this example, a bounding box 2A depicted in FIG. 2A includes the multi-modal bio-interfacing structure arrays 202 and portions of the contact lines 206 formed on the substrate 104. Only a single contact pad 204 and a single contact line 206 are denoted in FIG. 2A for clarity.

The bio-interfacing device 200 is an example alternative embodiment of the bio-interfacing device 100, and vice versa. For instance, the bio-interfacing device 200 may include the same structure, components, attributes, and functionality as that of the bio-interfacing device 100, and vice versa. A difference between the two devices is that the bio-interfacing device 200 in the example shown is embodied as a scaled-up version of the bio-interfacing device 100, including a plurality of multi-modal bio-interfacing structure arrays 202. As described further herein, each of the multi-modal bio-interfacing structure arrays 202 includes a plurality of multi-modal bio-interfacing structures 102 embodied as an array of micropillar electrodes 108 extending from a microelectrode pad 106, with a plurality of nanoantennas 110 formed on each of the micropillar electrodes 108. In contrast, the bio-interfacing device 100 includes a single micropillar electrode 108 extending from a microelectrode pad 106 with a plurality of nanoantennas 110 formed on the micropillar electrode 108.

In the example illustrated in FIGS. 2A to 2F, the multi-modal bio-interfacing structure arrays 202 are formed at an approximate center location of either or both of the substrate 104 and the bio-interfacing device 200, although other locations may be relied upon in some cases. The bio-interfacing device 200 in the example shown includes sixty of each of the multi-modal bio-interfacing structure arrays 202, the contact pads 204, and the contact lines 206 formed on the substrate 104, although other quantities of any or all of such components may be relied upon in some cases. Each of the contact pads 204, the contact lines 206, the microelectrode pads 106, and outer portions of the micropillar electrodes 108 may be respectively formed from different sections of a conductive layer 114, for instance, as described herein with reference to FIGS. 1A to 1D. In this example, the multi-modal bio-interfacing structure arrays 202, the contact pads 204, and the contact lines 206 are formed and respectively coupled to one another on the substrate 104 according to a certain pattern or coupling arrangement. However, other patterns and/or coupling arrangements of any or all of the multi-modal bio-interfacing structure arrays 202, the contact pads 204, and the contact lines 206 on the substrate 104 may be relied upon in some cases.

Although not illustrated, in some cases, the bio-interfacing device 200 may further include a passivation layer formed on at least a portion of one or more contact lines 206. The passivation layer may be formed on the contact lines 206 so as to encapsulate, protect, and/or insulate at least a portion of the contact lines 206 upon which the passivation layer is formed. For instance, the passivation layer may be formed on the contact lines 206 so as to encapsulate, protect, and/or insulate at least a portion of the conductive layer 114 used to form the contact lines 206 upon which the passivation layer is formed.

The passivation layer may be formed to a thickness ranging from approximately 500 nm to 2 micrometers (μm), although other thicknesses may be relied upon in some cases. The passivation layer may be formed using, and thus may include, for instance, at least one of a dielectric polymer (e.g., an epoxy-based negative photoresist material), a polyimide material, or a deposited dielectric material (e.g., silicon dioxide (SiO₂), titanium dioxide (TiO₂), or silicon nitride (Si₃N₄)), although other materials may be relied upon in some cases. In one example, the passivation layer may be formed on the contact lines 206 using a top-passivation process. The top-passivation process may include, for instance, at least one of a photolithography process, a physical vapor deposition (e.g., e-beam or sputtering) process, a chemical vapor deposition (e.g., atomic layer deposition) process, or dry and/or wet chemical etching process, or another top-passivation process.

FIG. 2B illustrates a top-down view of a plurality of multi-modal bio-interfacing structure arrays 202 respectively coupled to a plurality of contact lines 206 of the bio-interfacing device 200 according to at least one embodiment of the present disclosure. In this example, FIG. 2B illustrates a top-down view of the multi-modal bio-interfacing structure arrays 202 and portions of the contact lines 206 included in the bounding box 2A of FIG. 2A. In this example, a bounding box 2B depicted in FIG. 2B includes a subset of the multi-modal bio-interfacing structure arrays 202 and portions of a corresponding subset of the contact lines 206. Only a single multi-modal bio-interfacing structure array 202 and a single contact line 206 are denoted in FIG. 2B for clarity. In this example, the multi-modal bio-interfacing structure arrays 202 and the contact lines 206 are formed and respectively coupled to one another on the substrate 104 according to a certain pattern or coupling arrangement. However, other patterns and/or coupling arrangements of any or all of the multi-modal bio-interfacing structure arrays 202, the contact pads 204, and the contact lines 206 on the substrate 104 may be relied upon in some cases.

FIG. 2C illustrates a top-down view of a subset of multi-modal bio-interfacing structure arrays 202 respectively coupled to a subset of contact lines 206 of the bio-interfacing device 200 according to at least one embodiment of the present disclosure. In this example, each of the multi-modal bio-interfacing structure arrays 202 includes a plurality of multi-modal bio-interfacing structures 102 embodied as an array of micropillar electrodes 108 extending from a microelectrode pad 106, with a plurality of nanoantennas 110 formed on each of the micropillar electrodes 108 (FIGS. 2D, 2E, and 2F). In this example, FIG. 2C illustrates a top-down view of the multi-modal bio-interfacing structure arrays 202 and portions of the contact lines 206 included in the bounding box 2B of FIG. 2B. In this example, a bounding box 2C depicted in FIG. 2C includes a subset of micropillar electrodes 108 extending from a microelectrode pad 106 of a multi-modal bio-interfacing structure array 202 with a plurality of nanoantennas 110 formed on each of the micropillar electrodes 108 (FIGS. 2D, 2E, and 2F). Only a single microelectrode pad 106, a single micropillar electrode 108, a single multi-modal bio-interfacing structure array 202, and a single contact line 206 are denoted in FIG. 2C for clarity.

In the example shown, the micropillar electrodes 108 of each multi-modal bio-interfacing structure array 202 are formed and extend from the microelectrode pad 106 of each multi-modal bio-interfacing structure array 202 according to a certain pattern or orientation. However, other patterns and/or orientations of any or all of the micropillar electrodes 108 in any or all of the multi-modal bio-interfacing structure arrays 202 may be relied upon in some cases. The multi-modal bio-interfacing structure arrays 202 in the example shown each include sixteen micropillar electrodes 108 extending from a microelectrode pad 106, although other quantities of the micropillar electrodes 108 in any or all of the multi-modal bio-interfacing structure arrays 202 may be relied upon in some cases.

FIG. 2D illustrates a perspective view of a subset of micropillar electrodes 108 extending from a microelectrode pad 106 of a multi-modal bio-interfacing structure array 202 of the bio-interfacing device 200 according to at least one embodiment of the present disclosure. In this example, a plurality of nanoantennas 110 is formed on the microelectrode pad 106 and each of the micropillar electrodes 108. In this example, FIG. 2D illustrates a perspective view of the micropillar electrodes 108 included in the bounding box 2C of FIG. 2C, the micropillar electrodes 108 extending from the microelectrode pad 106 and having the nanoantennas 110 formed thereon. In this example, a bounding box 2D depicted in FIG. 2D includes the nanoantennas 110 formed on the micropillar electrode 108. Only a single micropillar electrode 108 is denoted in FIG. 2D for clarity.

The nanoantennas 110 in this example may be formed on at least one of the microelectrode pad 106 and the micropillar electrodes 108 as described herein with reference to FIGS. 1A to 1D and 3. In the example shown, the nanoantennas 110 are formed on the microelectrode pad 106 and the micropillar electrodes 108 according to a certain pattern or orientation. However, the nanoantennas 110 may be formed on the microelectrode pad 106 and/or any or all of the micropillar electrodes 108 of any or all of the multi-modal bio-interfacing structure arrays 202 according to one or more other patterns or orientations in some cases. The microelectrode pad 106 and the micropillar electrodes 108 in the example shown each include a certain number of nanoantennas 110 formed thereon, although other quantities of nanoantennas 110 may be formed on any or all of the microelectrode pads 106 and/or micropillar electrodes 108 in any or all of the multi-modal bio-interfacing structure arrays 202 in some cases.

FIG. 2E illustrates a perspective view of a subset of a plurality of nanoantennas 110 formed on a micropillar electrode 108 of a multi-modal bio-interfacing structure array 202 of the bio-interfacing device 200 according to at least one embodiment of the present disclosure. In this example, a bounding box 2E depicted in FIG. 2E includes a single nanoantenna 110 formed on the micropillar electrode 108. Only this nanoantenna 110 is denoted in FIG. 2E for clarity. In the example shown, the nanoantennas 110 are formed on a non-planar, curved surface (e.g., dome-shaped surface) of a distal end of the micropillar electrode 108 according to a certain pattern or orientation. However, the nanoantennas 110 may be formed on any surface geometry of any or all of the micropillar electrodes 108 of any or all of the multi-modal bio-interfacing structure arrays 202 according to one or more other patterns or orientations in some cases. The micropillar electrodes 108 in the example shown each include a certain number of nanoantennas 110 formed thereon, although other quantities of nanoantennas 110 may be formed on any or all of the micropillar electrodes 108 in any or all of the multi-modal bio-interfacing structure arrays 202 in some cases.

FIG. 2F illustrates a cross-sectional side-view of a nanoantenna 110 formed on a micropillar electrode 108 of a multi-modal bio-interfacing structure array 202 of the bio-interfacing device 200 according to at least one embodiment of the present disclosure. In this example, FIG. 2F illustrates a cross-sectional side-view of the nanoantenna 110 included in the bounding box 2E of FIG. 2E. In the example shown, the nanoantenna 110 is embodied as a multi-layer nanostructure including at least one of an adhesive layer (not illustrated in FIG. 2F for clarity), a noble metal layer 122, an interfacial adhesive layer (not illustrated in FIG. 2F for clarity), or a dielectric layer 124. In some cases, other layer types and/or various arrangements of such layers may be relied upon to form any or all of the nanoantennas 110. Only a single noble metal layer 122 and a single dielectric layer 124 are denoted in FIG. 2F for clarity. In the example shown, alternating deposits of an adhesive layer, the noble metal layer 122, an interfacial adhesive layer, and the dielectric layer 124 may be formed on a surface of the micropillar electrode 108 to construct the nanoantenna 110 on such a surface. In some cases, such layers may be deposited on the micropillar electrode 108 to form the nanoantenna 110 as described herein with reference to FIGS. 1A to 1D and 3. In the example shown, any or all of the nanoantennas 110 may be formed as described herein and illustrated in FIG. 2F.

In one example, the nanoantenna 110 includes a Cr layer as an adhesive later, an Au layer as the noble metal layer 122, a Ti layer as an interfacial adhesive layer, and an SiO₂ layer as the dielectric layer 124, although another material may be relied upon for any layer in some cases. The thickness of each of such layers may be the same in some cases or different in others. In some examples, the thickness of the adhesive layer (e.g., Cr layer) may range from approximately 0.1 to 5 nm thick, the thickness of the noble metal layer 122 (e.g., Au layer) may range from approximately 5 to 20 nm thick, the thickness of the interfacial adhesive layer (e.g., Ti layer) may range from approximately 0.1 to 5 nm thick, and the thickness of the dielectric layer 124 (e.g., SiO₂ layer) may range from approximately 5 to 20 nm thick, although another material and/or thickness may be relied upon for any or all of such layers in some cases. In one particular example, the adhesive layer may be formed as a Cr layer that is approximately 1 nm thick, the noble metal layer 120 may be formed as an Au layer that is approximately 12 nm thick, the interfacial adhesive layer may be formed as a Ti layer that is approximately 0.7 nm thick, and the dielectric layer 124 may be formed as an SiO₂ layer that is approximately 9 nm thick, although another material and/or thickness may be relied upon for any or all of such layers in some cases.

The bio-interfacing device 200 may be used to perform various bio-interfacing operations in different living systems. In one example, the bio-interfacing device 200 may be implemented to perform one or more sensing or interactive bio-interfacing operations in various living multicellular systems. For instance, the bio-interfacing device 200 may be implemented to perform at least one of bioelectrical, biochemical, biophotonic, or biomimetic operations in neuronal network cultures, stem-cell scaffolds, cancerous organoids, and microbial films, among other living systems. The bio-interfacing device 200 may be implemented to perform several of such bio-interfacing operations sequentially in some examples, or concurrently (e.g., simultaneously) in other examples.

The design of the multi-modal bio-interfacing structure arrays 202, the micropillar electrodes 108, the nanoantennas 110, the contact pads 204, and/or the contact lines 206 such as the shape, materials used, and material arrangement, among other aspects, may vary depending on a particular bio-interfacing application or to achieve a desired result from a particular bio-interfacing operation. The bio-interfacing device 200 and/or any of the components thereof, such as the multi-modal bio-interfacing structure arrays 202, the contact pads 204, and the contact lines 206, can be fabricated according to method 300 described herein with reference to FIG. 3. The method 300 provides a modular design approach and an integrated top-down fabrication process for fabricating multi-modal two-tier micro-/nano-optoelectrodes on a substrate to form one or more of the bio-interfacing devices described in examples herein.

FIG. 3 illustrates a flow diagram of an example fabrication method 300 according to at least one embodiment of the present disclosure. Example processing steps 302, 304, 306, 308, 310, 312, 314 of the method 300 are depicted in FIG. 3 and described herein. The method 300 can be implemented to fabricate either or both of the bio-interfacing device 100 and the bio-interfacing device 200 described herein with reference to FIGS. 1A to 2F. Although the method 300 is described herein in connection with fabricating numerous arrays of multi-modal bio-interfacing structures 102 (e.g., the multi-modal bio-interfacing structure arrays 202) on a substrate (e.g., the substrate 104), the method 300 is not so limited. For instance, the method 300 can be implemented to fabricate one or more multi-modal bio-interfacing structures 102 on a substrate 104 such that each of such structures at least includes a micropillar electrode 108 extending from a microelectrode pad 106 with a plurality of nanoantennas 110 formed on the micropillar electrode 108. For clarity, FIG. 3 only depicts the processing steps 302, 304, 306, 308, 310, 312, 314 for a single multi-modal bio-interfacing structure array, such as, for instance, a single multi-modal bio-interfacing structure array 202. However, such processing steps of the method 300 may be implemented as described herein to fabricate a plurality of multi-modal bio-interfacing structure arrays on a substrate.

The method 300 illustrated in FIG. 3 is an example procedure for fabricating one or more two-tier protruding micro-nano optoelectrode structures (e.g., the multi-modal bio-interfacing structure 102), or arrays thereof (e.g., the multi-modal bio-interfacing structure arrays 202), on a substrate (e.g., the substrate 104) in a modularized, scalable, and complementary metal-oxide-semiconductor (CMOS) compatible manufacturing process. The method 300 involves a combination of microscale photolithography, phase-shifting lithography, and thin-film physical vapor deposition (PVD) to allow for control of the geometry and material processing parameters for the micropillar electrode 108, the microelectrode pad 106, and the nanoantennas 110.

At the processing step 302, the nanofabrication procedure of the method 300 begins with the patterning of several polymeric micropillars 112 as a superlattice array of, for instance, polymeric micropillars on a silicon wafer using, for example, at least one of photolithography, direct-write photolithography (e.g., a maskless approach), or contact photolithography (e.g., a masked approach). In one example, such polymeric micropillars (e.g., the polymeric micropillars 112) may be patterned on a substrate (e.g., the substrate 104) using direct-write photolithography (DWPL). The polymeric micropillars 112 may be formed as a superlattice array of, for instance, epoxy-based negative photoresist micropillars in one example. The polymeric micropillars 112 may each be formed to a diameter that ranges from approximately 1 to 10 millimeters (mm) and to a height that ranges from approximately 1 to 10 mm, although other diameter and/or height values may be relied upon in some cases. In one particular example, the polymeric micropillars 112 may each be formed to a diameter of approximately 2.5 mm and to a height of approximately 5 mm. In some cases, the polymeric micropillars 112 may be formed on the substrate 104 in a defined pattern using DWPL. Alignment markers (not illustrated) may be used in at least one example to ensure precise overlap between the polymeric micropillars 112 and a multi-electrode array (MEA) pattern.

At the processing steps 304 and 306, collectively, the method 300 includes defining the microelectrodes, contact pads, and contact lines such as, for instance, the microelectrode pads 106, the contact pads 204, and the contact lines 206, respectively. In some examples, such components may be defined by spin-coating and DWPL of a bilayer resist stack on top of the protruding micropillar MEA (e.g., on top of the polymeric micropillars 112). The bilayer resist stack in one example includes a positive-tone photoresist (PR) and a lift-off resist on top of the protruding micropillar MEA (e.g., on top of the polymeric micropillars 112). In some examples, the bilayer resist stack may include a positive-tone PR having a thickness ranging between approximately 0.5 to 2 mm and a lift-off resist having a thickness ranging between approximately 400 to 600 nm. In one particular example, the microelectrode pads 106, the contact pads 204, and the contact lines 206 may be defined by spin-coating and DWPL of a bilayer resist stack consisting of an approximately 1.3 mm thick positive-tone PR and an approximately 500 nm thick lift-off resist on top of the protruding micropillar MEA (e.g., the polymeric micropillars 112). Subsequently, an undercut may be developed in the bilayer photoresist stack for thin-film deposition, as described herein in at least one example. For instance, the undercut may be developed in the bilayer photoresist stack to pattern at least one of the microelectrode pad 106, the contact pads 204, or the contact lines 206 for thin-film deposition. In this example, such thin-film deposition may be performed as described below at processing step 308.

At the processing step 308, the method 300 includes deposition of at least one layer of SiO₂, Cr, and Au on the bilayer photoresist stack by, for instance, magnetron sputtering PVD to form a conductive layer 114. For instance, at least one of the dielectric layer 116, the adhesive layer 118, or the noble metal layer 120 may be deposited on the bilayer photoresist stack by magnetron sputtering PVD. In one particular example, a conductive layer 114, including approximately 30 nm of SiO₂, approximately 10 nm of Cr, and approximately 100 nm of Au may be deposited on the bilayer photoresist stack by magnetron sputtering PVD. Deposition of such layers of the conductive layer 114 by magnetron sputtering PVD can achieve conformal top and sidewall coating of the polymeric micropillars 112 to form the micropillar electrodes 108. Deposition of such layers of the conductive layer 114 by magnetron sputtering PVD can also achieve conformal coating of top surfaces of defined portions on the substrate 104 to form the microelectrode pads 106, the contact pads 204, and the contact lines 206. Deposition of such layers of the conductive layer 114 by magnetron sputtering PVD can also structurally integrate and anchor the micropillar electrode 108 to each of the microelectrode pads 106 with corresponding contact lines 206 and pads 204 for the electrical and/or optical interface.

At the processing step 310, the method 300 includes, for instance, spin-coating and DWPL of an additional positive tone PR layer to mask the entire substrate 104 except for the microelectrode pads 106 regions, selectively constraining such regions for nanoscale pattern transfer during the PVD process.

At the processing step 312, the method 300 includes transferring onto the additional positive tone PR layer, for example, a precut 1 cm×1 cm Au film perforated with an ordered nanohole array (AuNHA). In some cases, the AuNHA film may be prefabricated using soft interference lithography with a resultant nominal hole diameter ranging between approximately 100 to 150 nm and periodicity ranging between approximately 300 to 500 nm. In one particular example, the AuNHA film may be prefabricated using soft interference lithography with a resultant nominal hole diameter of approximately 130 nm and periodicity of approximately 400 nm. For the transfer process in the example shown, the AuNHA film may be lifted off from its carrier substrate, then transferred and resuspended in a water-filled glass dish. This allows for a glass slide (e.g., 75 mm×26 mm) to be submerged into the water in the dish to remove the AuNHA film in a scooping manner. Prior oxygen plasma treatment of the microscope slide may result in a hydrophilic surface and improve the scooping process in some cases. The AuNHA film may be subsequently transferred onto the micropillar electrodes 108 in some examples by positioning one edge of the glass slide directly over the center of the substrate 104 with a slight angle (e.g., 0.5 degrees (°), 1°, 5°, 10°) and simultaneously using a plastic pipette to provide a stream of water, thereby allowing for dragging (e.g., via a water droplet) of the AuNHA film from the glass slide onto the additional positive tone PR layer and the micropillar electrodes 108. The remaining water underneath the AuNHA film may be left to evaporate at room temperature.

To create the AuNHA film as a deposition mask, an established protocol adapted from the phase-shifting photolithography, etching, electron-beam deposition and lift-off (PEEL) technique may be used in some examples. For instance, a free-standing film of AuNHA may be used as a physical deposition mask to create periodic arrays of discrete multilayered nanoantennas. To fabricate the AuNHA film in one example, a poly(dimethylsiloxane) (PDMS) photomask replicated from a silicon master patterned with nanopillar arrays may be used to expose a positive-tone photoresist (PR) on a silicon wafer in contact mode. After exposure and development of PR nanopillar arrays, a Cr layer (e.g., approximately 10 nm) may be deposited in this example using physical vapor deposition (PVD) by electron-beam (e-beam) evaporation, followed by sonication with acetone to lift off the nanopillar arrays and create Cr nanohole arrays on the silicon wafer. Using reactive ion etching with O₂ and CF₄ mixtures (e.g., 1:5) in this example, an undercut in the silicon wafer may be etched under the Cr nanohole arrays, followed by the e-beam PVD of an approximately 160 nm thick Au layer on top of the Cr layer. The AuNHA film may be lifted off using Cr etchant in this example and handled with a plasma-treated glass slide, scooping it from the Cr etchant dish and transferring it to a water-filled dish. As described above, in the example shown, the AuNHA film may be transferred onto the additional positive tone PR and the micropillar electrodes 108 from the water dish by suspending and transporting the AuNHA film in a water droplet on the glass slide. After transferring the AuNHA film by tilting the glass slide over the center of the substrate 104, the water droplet underneath the AuNHA film may be allowed to evaporate steadily at room temperature in this example. In this way, any potential wrapping and/or compression of the AuNHA film onto any of the micropillar electrodes 108, which may result if rapid evaporation is employed, can be avoided.

At the processing step 314, the method 300 includes depositing alternating layers of Au (e.g., the noble metal layer 122) and SiO₂ (e.g., the dielectric layer 124) by, for instance, electron-beam evaporation PVD to form a plurality of nanoantennas 110 on the microelectrode pads 106 and the micropillar electrodes 108. In one particular example, alternating layers of Au and SiO₂ that are each approximately 12 nm and 9 nm thick, respectively, may be deposited by electron-beam evaporation PVD without substrate rotation to maintain a direct line-of-sight between the sample and crucible. In some examples, a layer of Cr that is approximately 1 nm thick may also be deposited as an adhesion layer with an outer Au layer (e.g., the noble metal layer 120) of the micropillar electrodes 108. In some examples, a layer of Ti that is approximately 0.7 nm thick may also be deposited as an interfacial adhesion layer between each Au layer and SiO₂ layer.

At the processing step 316, the method 300 includes lifting-off the AuNHA film using, for example, a 1-methyl-2-pyrrolidone (NMP) based solvent stripper to complete the lift-off process and reveal metalized MEA pattern (e.g., a multi-modal bio-interfacing structure array 202) on the substrate 104. An inset in FIG. 3 shows a cross-sectional view of a nanoantenna 110 formed according to one example implementation of the method 300.

Although not illustrated in FIG. 3, in one example, the method 300 for fabricating micro-/nano-optoelectrodes begins by precleaning a three-inch diameter Si wafer with oxygen plasma (e.g., 50 W, 1 minute (min), 50 cm³/min of O₂), followed by spin-coating with positive-tone photoresist (PR) at 3000 revolutions per min for 30 seconds(s). The resist may then be prebaked in this example on a hotplate set for 2 min at 95° C., and a mask design, containing micropillar arrays, is exposed onto an epoxy-based negative photoresist material using a maskless aligner (e.g., via direct-write photolithography, DWPL). Automated features of the DWPL tool may be used in this example to quickly generate a focus-exposure matrix, allowing for determination of the optimal exposure dose of around 100 millijoules (mJ)/cm² with the 375 nm laser and optimal defocus value around 0. After PR exposure, the exposed PR on the silicon wafer may be baked in this example using a hot plate for 3 min at 95° C., and the pattern may be developed by immersing the wafer in a dish containing epoxy-based negative photoresist developer for approximately 2 min to 3 min. Next, the wafer may be rinsed in this example with isopropyl alcohol and blow-dried with a nitrogen (N₂) flow. Lastly, the target epoxy-based negative photoresist micropillar structures on the silicon wafer may be hard baked in this example at 180° C. for 45 mins.

Following a similar procedure, a bilayer resist stack may be prepared in this example by first spin-coating a lift-off resist at 3000 revolutions per min for 45 s, followed by baking on a hotplate set at 180° C. for 5 mins; the second layer consisting of positive photoresist may be spin-coated at 4000 revolutions per min and baked at 115° C. for 1 min in this example. Another mask design, which may include the microelectrodes, contact pads, and lines, may be exposed in this example. Similar to before, in this example a focus-exposure matrix may be used to find the optimal exposure and focus with 405 nm wavelength laser conditions around 150 mJ/cm² and 0, respectively. Alignment markers may be patterned in this example to ensure proper overlap between each square microelectrode and 4×4 micropillar array. After PR exposure, the wafer in this example may be immersed in tetramethylammonium hydroxide (TMAH) for approximately 1 min and 40 s to create an undercut in the lift-off layer and transferred to a dish containing deionized (DI) water for 30 s to stop the development process. In this example, any excess exposed PR may be rinsed with DI water, gently streamed from a wash bottle. Any excess resist beyond development can be “descummed” in this example using plasma treatment, but descumming prior to deposition may be omitted from other examples of the method 300.

The direct current and radio-frequency sputtering guns in a commercial sputtering PVD system may be used to deposit 10 nm of SiO₂, 30 nm of Cr, and 100 nm of Au in this example while the substrate is rotated. Sputter PVD may be followed in this example by the spin-coating of a positive PR, which may then be soft-baked and exposed to define a clear window for only the microelectrode regions with the rest of the wafer being masked. The prefabricated AuNHA film may then be transferred in this example onto the wafer, and e-beam PVD may be conducted without substrate rotation to deposit alternating layers of 12 nm thick Au and 9 nm thick SiO₂ layers with 1 nm thick Ti interfacial adhesion layer between each metal-insulator interface. The deposition in this example may be performed at a high vacuum <1.33×10⁻⁴ pascals (Pa). After e-beam PVD, the wafer in this example may be submerged in a double PR stripper bath for 2 hours (h), with the development processes accelerated by periodic agitation from shaking the bath dish. After completing the lift-off process, a final passivation layer composed of an epoxy-based negative photoresist can be spin-coated, prebaked, exposed, post-exposure baked, developed, and hard baked in this example similarly as the micropillar fabrication procedure. Additionally, in some examples, mesh electronics can be derived from this fabrication procedure by including a nickel (Ni) sacrificial layer and a bottom passivation layer before creating the epoxy-based negative photoresist micropillars.

Disjunctive language, such as the phrase “at least one of X, Y, or Z,” unless specifically stated otherwise, is to be understood with the context as used in general to present that an item, term, or the like, can be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present. As referenced herein in the context of quantity, the terms “a” or “an” are intended to mean “at least one” and are not intended to imply “one and only one.”

As referred to herein, the terms “include,” “includes,” and “including” are intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify the location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, at least the following is claimed:

1. A device for bio-interfacing applications, the device comprising:
a substrate; and
a multi-modal bio-interfacing structure formed on the substrate, the multi-modal bio-interfacing structure comprising:
a microelectrode pad formed on the substrate;
a micropillar electrode extending from the microelectrode pad; and
a plurality of nanoantennas formed on the micropillar electrode.

2. The device of claim 1, wherein the micropillar electrode comprises:
a polymeric micropillar extending from the substrate; and
a conductive layer formed on the polymeric micropillar.

3. The device of claim 2, wherein the polymeric micropillar comprises at least one of a polymer material, a perfluoropolyether material, a photoinitiator material, a polyurethane material, or an epoxy-based negative photoresist material.

4. The device of claim 2, wherein the conductive layer comprises at least one of a dielectric layer, an adhesive layer, or a noble metal layer.

5. The device of claim 1, wherein at least one of the plurality of nanoantennas comprises a multi-layer nanostructure comprising at least one of an adhesive layer, a noble metal layer, an interfacial adhesive layer, or a dielectric layer.

6. The device of claim 1, wherein the plurality of nanoantennas comprises an array of optical nanoantennas.

7. The device of claim 1, wherein the plurality of nanoantennas comprises an array of multi-resonant plasmonic nanoantennas.

8. The device of claim 1, wherein the plurality of nanoantennas is formed on the micropillar electrode in a defined pattern.

9. The device of claim 1, wherein the plurality of nanoantennas is formed on at least one of a non-planar surface or a curved surface of a distal end of the micropillar electrode.

10. The device of claim 1, wherein the plurality of nanoantennas is further formed on the microelectrode pad and on at least one of a non-planar surface or a curved surface of a distal end of the micropillar electrode, the plurality of nanoantennas being formed in a defined pattern on the microelectrode pad and on at least one of the non-planar surface or the curved surface of the distal end of the micropillar electrode.

11. The device of claim 1, further comprising:
a contact line formed on the substrate and coupled to at least one of the microelectrode pad, the micropillar electrode, or the plurality of nanoantennas;
a passivation layer formed on the contact line, the passivation layer at least partly encapsulating and insulating the contact line; and
a contact pad formed on the substrate and coupled to the contact line.

12. The device of claim 1, wherein the multi-modal bio-interfacing structure comprises at least one of a bioelectrical microelectrode, a biochemical microelectrode, a bioelectrical-biochemical microelectrode, a biophotonic microelectrode, or a biomimetic microelectrode.

13. A method for forming a multi-modal bio-interfacing structure on a substrate, the method comprising:
forming at least one polymeric micropillar on the substrate;
forming a conductive layer on the substrate and the at least one polymeric micropillar, to respectively form a microelectrode pad on the substrate and at least one micropillar electrode extending from the microelectrode pad; and
forming a plurality of nanoantennas on the at least one micropillar electrode.

14. The method of claim 13, wherein forming the at least one polymeric micropillar on the substrate comprises:
forming at least one micropillar of an epoxy-based negative photoresist material on the substrate in a defined pattern using at least one of photolithography, direct-write photolithography, or contact photolithography, the at least one micropillar of the epoxy-based negative photoresist material being formed to extend from the substrate.

15. The method of claim 13, wherein forming the conductive layer on the substrate and the at least one polymeric micropillar comprises:
depositing a dielectric layer, an adhesive layer, and a noble metal layer on the substrate and the at least one polymeric micropillar using magnetron sputtering physical vapor deposition.

16. The method of claim 13, wherein forming the plurality of nanoantennas on the at least one micropillar electrode comprises:
depositing an adhesive layer, a noble metal layer, an interfacial adhesive layer, and a dielectric layer on the substrate and the at least one micropillar electrode in a defined pattern using electron-beam evaporation physical vapor deposition and a perforated mask having nanoholes that collectively form the defined pattern.

17. The method of claim 13, wherein forming the plurality of nanoantennas on the at least one micropillar electrode comprises:
forming the plurality of nanoantennas on at least one of a non-planar surface or a curved surface of a distal end of the at least one micropillar electrode.

18. The method of claim 13, further comprising:
forming the plurality of nanoantennas on the microelectrode pad and on at least one of a non-planar surface or a curved surface of a distal end of the at least one micropillar electrode, the plurality of nanoantennas being formed in a defined pattern on the microelectrode pad and on at least one of the non-planar surface or the curved surface of the distal end of the at least one micropillar electrode.

19. The method of claim 13, further comprising:
forming a contact line on the substrate, the contact line being coupled to at least one of the microelectrode pad, the at least one micropillar electrode, or the plurality of nanoantennas;
forming a passivation layer on the contact line, the passivation layer at least partly encapsulating and insulating the contact line; and
forming a contact pad on the substrate, the contact pad being coupled to the contact line.

20. A method for bio-interfacing with multicellular systems, comprising:
performing at least one bio-interfacing operation in connection with a multicellular system using a bio-interfacing device having a multi-modal bio-interfacing structure, the multi-modal bio-interfacing structure comprising:
a microelectrode pad formed on a substrate;
a micropillar electrode extending from the microelectrode pad; and
a plurality of nanoantennas formed on the micropillar electrode.
